(19) United States
(12) Patent Application Publication
(10) Pub. No.: US 2002/0116239 A1
(43) Pub. Date: Aug. 22, 2002

(54) Systems and methods for optimizing building materials

(76) Inventors: Jeffrey Dean Reinsma, Littleton, CO (US); Reed H. Larson, Parker, CO (US); Arnold E. Spriggs, Englewood, CO (US)

Correspondence Address: E. Joseph Gess, BURNS, DOANE, SWECKER & MATHIS, L.L.P., P.O. Box 1404, Alexandria, VA, 22313-1404, US

(21) Appl. No.: 09/788,470

(22) Filed: Feb. 21, 2001

(51) Int. Cl. G06F 17/60

(52) U.S. Cl. 705/7; 705/11

(57) ABSTRACT

A system for optimization, where a lowest cost set of building materials or systems that may be used in constructing a structure within given criteria is determined. Project information is inputted into the system, and sets of items, including energy-related products and systems, are determined to be usable based on the project information and given criteria, which may be a desired target or a building code. A value, such as total cost, is calculated for each determined set of items and the set of items with the lowest value is selected and displayed for a user. A starting point for the optimization process may be determined by calculating a project value of the structure, such a glazing area percentage, and starting an iterating process with items associated with the calculated project value. The system may be implemented over a computer network, such as the Internet, an intranet, a LAN, or a WAN.

### BACKGROUND OF THE INVENTION

1. Field of the Invention

This invention relates generally to the field of optimization, and in particular to the optimization of items used in a given application while complying with a set of criteria. More specifically, the invention relates to the determination of a lowest cost set of building materials or systems that may be used in constructing a structure while achieving a target level, for example, complying with an energy code.

2. Background Information

The completion of a particular project, such as the construction of a building, requires the use of an assortment of items, including building materials and systems. Designers or engineers often have some discretion in selecting project items, as long as overriding criteria are met. For example, in a construction project, a variety of materials may be used as long as the final product achieves a selected performance level or satisfies a given code. Due to the complexity of many projects, as well as the wide variety of candidate materials and systems (and their interactions and trade-offs), it is often difficult to determine whether the lowest cost set of items has been selected. One simple method of complying with a target, such as a code, involves selecting materials and systems that are known to satisfy the target's requirement, without considering either associated capital or lifetime costs. However, in the interest of remaining competitive in today's global marketplace, professionals (such as manufacturers, builders, engineers, contractors, and architects) must be concerned about cost optimization, which can help such individuals leverage their materials investments throughout an enterprise, thereby providing a competitive advantage.

### SUMMARY OF THE INVENTION

The present invention is directed to the determination of a lowest cost set of items, such as energy-related products and systems, while satisfying a given set of criteria.

According to a first embodiment of the present invention, a method is provided for selecting items for a project within a criteria, the method comprising the steps of inputting project information, determining sets of items based on the project information that meet the criteria, calculating for each set of items a set value, and selecting a set of items based on the calculated set values.

According to a second embodiment of the present invention, a system is provided for selecting a set of items that meet a given criteria when included within a project, the system comprising a central computer having a processor and an input device for receiving information on a project, at least one database having a list of items that may be used in constructing the project and a first value for each of the items, code for determining sets of the items that may be used in constructing the project, code for calculating a total first values for each set of items, and code for selecting a set of items based on the calculated total first values.

According to a third embodiment of the present invention, a method is provided for optimizing item costs used in an application within a given criteria, the method comprising the steps of inputting into a processor information on the project, determining with the processor sets of items that may be used with the project that meet the given criteria, calculating with the processor the cost of each set of items to determine a lowest cost set, and producing a visual display of the lowest cost set.

According to a fourth embodiment of the present invention, a method is provided for optimizing building material costs used in constructing a structure while complying with a given code, the method comprising the steps of inputting into a computer having a processor information on the structure, determining with the processor sets of building materials that may be used in constructing the structure while complying with a given code, calculating with the processor the cost of each set of building materials to determine a lowest cost set, and producing a visual display of the lowest cost set.

According to a fifth embodiment of the present invention, a method is provided for optimizing building material costs used in constructing a structure while complying with a given code, the method comprising the steps of receiving at a network server computer having a processor information on a structure, determining with the processor sets of building materials that may be used in constructing the structure while complying with a given code, calculating with the processor the cost of each set of building materials to determine a lowest cost set, and transmitting information on the lowest cost set to a user computer over a network.

According to a sixth embodiment of the present invention, a system is provided for selecting a lowest set cost associated with a set of items that meet a given criteria, the system comprising a central computer having a processor and an input device for receiving information on a structure, at least one database having a list of items that may be used in constructing the structure and an item cost associated with each item, code to determine sets of the items that may be used in constructing the structure, code to calculate a set cost for each set of items, and code to determine the lowest set cost.

### BRIEF DESCRIPTION OF THE DRAWINGS

Other objects and advantages of the present invention will become more apparent from the following detailed description of preferred embodiments, when read in conjunction with the accompanying drawings wherein like elements have been represented by like reference numerals and wherein:

FIG. 1 is a block diagram of one embodiment of a code compliance optimization system according to one embodiment of the present invention;

FIG. 2 is a schematic diagram of a target compliance optimization system according to one embodiment of the present invention;

FIG. 3 is a schematic diagram of a target compliance optimization system that is implemented using a computer network according to one embodiment of the present invention;

FIGS. 4 and 4A form a flow chart illustrating one method for planning the construction of a structure according to one embodiment of the present invention;

FIGS. 5 and 5A form a flow chart illustrating another method for planning the construction of a structure according to one embodiment of the present invention; and

FIG. 6 is a flow chart illustrating one method for optimizing item costs according to one embodiment of the present invention.

### DETAILED DESCRIPTION OF THE INVENTION

The present invention provides for the optimizing of item values associated with a project or application while meeting certain criteria, and may be used in a wide variety of applications employing a wide variety of items. For example, the items may comprise building materials or systems used in constructing a building. These items may, in addition, be energy-saving or energy-related products or systems, such as insulation material (categorized by an insulation R-value) or a HVAC system, which includes subsystems of ducting, furnaces, etc. An exemplary embodiment of invention is used to optimize building materials or system costs (e.g., initial or lifetime) while still complying with one or more criteria, such as target codes. For instance, the embodiment may be used to optimize plumbing material costs while meeting a plumbing code, to optimize structural material costs while complying with a building code, or to optimize energy-using or energy-saving materials and/or systems costs while complying with an energy code, an example of which is the International Energy Conservation Code (IECC) of the International Code Council (ICC). Other applications where item costs may be optimized while still meeting certain criteria include electrical or foundation work.

The method of an exemplary embodiment of the present invention begins with the inputting of project information (either manually or electronically), which may include information on various structural elements that are used to construct a structure, as well as the configuration of the structure itself. For example, the structure information may comprise information on the main walls, ceilings, floors, basement walls, slab perimeter, crawl space, and the like. Such information may also include details on the surrounding environment, such as geographical location or available shading (e.g., from trees, overhangs, or other buildings). For situations where inputted project information is associated with an existing structure (e.g., an existing building in need of a retrofit upgrade), the present invention is able to recommend changes to the structure to achieve compliance with a chosen target (e.g., an energy code), based on the results of the following steps.

Subsequent steps of the exemplary method involve determining sets of items based on the inputted project information that meet an established criteria, calculating for each set of items a set value, and selecting a set of items based on the calculated set values. These steps may represent a process of cost optimization when the set values are, for example, related to summed item costs. To optimize costs, an exemplary embodiment iterates through various combinations of items to determine possible combinations or sets of items that may be used in a building and that meet target requirements. Conveniently, information relating to the items and associated costs are stored in a central database. In this way, the cost of each set may be determined by simply extracting the cost information from the database, and by summing the costs to provide a cost for each set. The set costs may then be compared to determine the lowest cost set. Alternatively, cost information may be stored in remote locations, which may be accessed, for example, via Internet hyperlinks.

Optimization may be based on any type of energy code or target, such as a set energy level or “budget,” which may be a baseline value represented in thermal units (e.g., Btu). In the following example, the requirements of the IECC is used as the target. The IECC uses U-values or R-values as a criteria to determine whether a building assembly meets a specified energy budget. The U-value or R-value of an assembly may be increased or decreased provided that the total heat gain or loss for the entire building does not exceed the total resulting from conformance to the specified values. The overall structure performance can be determined by calculating a first project value, such as a UA value.

Briefly, the UA value for a structure is computed by calculating U-values for each type of surface, such as ceilings, walls, floors, foundations and the like, and multiplying each U-value by the corresponding area. U-values are a measure of how well a material or series of materials conducts heat and have units of Btu/h ft² F. U-values for window and door assemblies are the reciprocal of the assembly R-value; i.e., U-value=1/(R Value). An R-value (h Ft² F/Btu) is a measure of thermal resistance, i.e., how well a material, or a series of materials, resists the flow of heat. For building assemblies such as a wall assemblies, the R-value in the above equation is the R-value of the entire assembly, not just of one component, such as insulation, for example.

Hence, sets of items that meet a target requirement, such as the IECC or an energy budget, may be determined by iterating through items having different thermal characteristics (e.g., R-values) for each area of the building, and by determining which sets produce an acceptable value. In a situation where the IECC represents the desired target, one method to comply is to represent a set value by a UA value, where the UA value is acceptable when the code-specified UA value is not exceeded. When using an energy budget compliance method, a set value is represented by a total energy level, and is acceptable when the established energy baseline is not exceeded by this level. Software packages for calculating UA values for a given structure include MECcheck™, available from Pacific Northwest Laboratory, for the U.S. Department of Energy. Such software packages require that information on the structure be input into a database. Such information may include information on the walls, ceilings, floors, glazing, crawl space, and slab perimeter. Conveniently, such information may also be extracted from CAD/CAM drawings or similar methods.

An optimization including more building features and systems can be performed by projecting total annual energy consumption compared to a base building or “standard design.” Energy codes define certain parameters for the standard design, while insulation values, glazing areas, equipment efficiencies, and other energy-saving features can vary. To increase the efficiency of the optimization, the invention provides techniques for judicially choosing a starting point for the optimization.

In an exemplary embodiment, a second project value, such as a glazing area percentage, is calculated for the structure based on the inputted project information. Glazing is any translucent or transparent material (e.g., glass) positioned in the exterior openings of buildings. Glazing includes, for example, windows, skylights, sliding glass doors, glass areas of opaque doors, and glass blocks. The area of glazing is the exterior surface area of such assemblies, and a glazing area percentage may be calculated by dividing a glazing area value by a total gross exterior wall area. Recommended R-values for a given glazing area percentage are, for example, set forth in the IECC prescriptive requirement tables. Once glazing area percentages have been calculated, the IECC tables may be searched to find the R-values that are associated with the glazing area percentages.

These R-values can be used as a starting point since they are known to meet code requirements. Glazing area percentages and associated R-values that are within a certain range of the calculated glazing area percentage are then identified. The algorithm iterates through all possible combinations of these R-values to determine sets of items that are in compliance with the code. Conveniently, the IECC glazing and R-value tables may be stored in a relational database, such as an Excel relational database.

In the above example, a user may be presented with different categories of glazing to be used in the optimization, where each category contains multiple glazing types. For example, one category may be “bay windows”, and types within that category may be bay windows of various dimensions and/or U-values. From the presented categories, the user may select a type of glazing from within a category (e.g., a particular size and type of window) or an entire glazing category to be used in the algorithm. A user may also omit a particular type or an entire glazing category from the optimization.

In some cases, a user may wish to upgrade from any specified requirements to increase thermal efficiency and/or to reduce energy costs. For example, the user may wish to construct a building that exceeds the requirements of the IECC by a certain percentage, for example, by increasing what could be termed as an indoor thermal quality (ITQ). The term ITQ generally refers to the level of comfort that might be desirable for economic, environmental, physical health, psychological health, and comfort reasons, and encompasses factors in addition to energy efficiency, such as humidity or temperature gradients. The invention permits the user to request such an upgrade, and this may be accomplished, for example, by decreasing the UA value or the energy consumption target by a certain amount and rerunning the optimization algorithm.

In another alternative, the user may wish to use various other types of items or energy saving materials when constructing the building in an attempt to increase the buildings thermal efficiency. Such materials may include, for example, added thermal mass, radiant barriers, air leakage controls, and insulated ducts. The system permits such materials to be input into the database, and then reoptimizes to determine a lowest cost set of items when using the additional materials. In addition, a user may specify elements to be excluded from the optimization process. For example, a particular user may wish to install a particular window in a structure regardless of the window's thermal characteristics. In such a case, the window and its properties are included in an energy compliance calculation, but are excluded from (or held constant in) the cost optimization algorithm.

In one option, the system also provides energy consumption estimates based on historical climate data and on the particular type of climate control equipment (e.g., furnace, air conditioner, etc.) used in the building. In this way, a user is able to estimate energy costs based on the type of items package that is requested. For example, the user may wish to increase the ITQ by 20%. The system provides an estimate of energy costs and material costs for baseline and for a 20% increase. In this way, the user can determine whether the upgrade is economically justified, with the system taking into account such economical conditions as fuel costs and interest rates. A similar analysis may be provided when additional energy saving materials are used in the construction.

The system may also provide the option of analyzing interactions between energy-related or energy-saving items. An interaction or “trade-off” refers to the relationship between the performance value (e.g., R-value) and cost of one item and the performance value and cost of at least another item. In analyzing the interactions between two items, for example, the performance value (e.g., R-value) for one item might be increased, while the performance value for another item is decreased. A resulting system performance value and the costs associated with these changes can be analyzed to determine an optimal balance between the items. For example, when an insulation material with a relatively high performance value is added into a structure, a HVAC system smaller than an originally designed HVAC system may be used to reduce overall cost, while still conforming to a target requirement for the system or building.

The system may also be able to redesign heating and cooling system configurations based on optimization results. In other words, an HVAC design originally submitted as part of the project information may be modified to more efficiently distribute conditioned air. Similarly, water, electrical, and solar heat systems may also be redesigned.

Trade-offs between item costs and structural costs (e.g., costs associated with wall, floor, or ceiling assemblies) can also be analyzed to achieve a balanced and cost-effective structure. For example, more insulation material (or insulation material with a greater performance value) may be used if a structural change, such as an increase in wall component size (such as from 2′×4′ to 2′×6′), results in a higher performance value. In this way, while an overall cost for a structure (or areas of a structure) may be increased, a cost-savings associated with energy may be ultimately realized and may offset the increased structural cost.

As previously described, the optimization system may utilize target-compliant databases. The optimizer system in one embodiment iterates for maximum efficiency and speed in retrieval, and determines the maximum and minimum applicable values of the code evaluation tables. Optimization of the code may be established by determining the fitness of the genetic component within the code's minimum requirements while insuring a minimum cost compared to other acceptable candidates. The method of code optimization may be carried out using a suitable optimization engine, such as a multi-staged genetic algorithm drawing data from a relational database. The optimization system may utilize multiple data sources, including computerized files, relational databases (RDBs), and hierarchical databases, that bring data from different sources into a single database for in-depth data optimization of a user's input.

In one aspect of the invention, the optimizer system may use a multi-agent genetic algorithm and reinforced learning algorithms when performing the optimization. Each agent in a team of reinforced learning algorithms controls a particular “elevator car” cooperatively solving the entire problem. The reinforced learning algorithm comparisons are compiled and reported as the relationships between past based results and current actual results are discovered. In this way, optimum comparisons are provided against code and costs.

Genetic algorithm-based systems for selecting solutions generally include code to evaluate solutions according to a pre-selected evaluation function. For example, a first computer may generate a first population of solutions, the first population of solutions being of a first representation scheme. A second computer may then generate a second population of solutions, with the second population of solutions being of a second representation scheme. A translator translates the solutions of the second representation scheme into equivalent solutions of the first representation scheme. Code may also be provided to introduce solutions from the second population into the first population solutions.

Genetic algorithms are a well known optimizing technique and are described generally in “Genetic Algorithms for the traveling salesman problem”, Grefenstette et al., Process intern conference of Genetic Algorithms and their applications, pp. 1160-165 (1985), and “Handbook of genetic algorithms”, Davis, L., Van Nostrand Reinhold, New York (1991), the complete disclosures of which are herein incorporated by reference in their entirety. Genetic algorithms are guided by a schema theory, which states that the more favorable a particular choice of values for a subset of solution parameters is, the more frequently the schema appears as part of the solutions in the population. These building blocks represent the preferred values of the solution parameters and their combinations.

Reinforced learning algorithms are employed to make decisions which result in better solutions over time. Reinforced learning algorithms are similar to Markov decision processes which model problems with delayed reinforcement. Markov decision processes are defined by a set of Markov states, the actions available in those states, the transition probabilities and the rewards associated with each state-action pair. Model-based reinforced learning algorithms explicitly look for Markov decision process solutions, an optimal policy, which is a mapping from Markov decision processes states to actions which maximize the expected average reward received by following a path through Markov decision process states. An action value function for a policy is defined as a mapping from each state action pair to the expected average reward obtained by choosing an action in that state to the given policy, and following that policy thereafter. The state value function for a policy specifies the desirability of a state and is defined as the expected average reward obtained by following that policy from a given state.

Reinforced learning algorithms are described generally in Reinforced Learning: An Introduction, Sutton, R. and Barto, A., MIT Press (1997), Optimization, Learning and Natural Algorithms, Dorigo, M., Ph.D. thesis, Politecnico di Milano, Italy (1992), and “Global Search in Combinatorial Optimization using Reinforced Learning Algorithms”, Miagkikh, V. and Punch, W., MSU Genetic Algorithms Research and Application Group (1998), the complete disclosures of which are herein incorporated by reference in their entirety.

The optimizer system of the invention may use a combination of genetic and reinforced learning algorithms to competitively replace a given set of costs. For example, if a “new result” is better than the “past result,” which serves as the source of a replicated result, then the “new result” would inherit all of the preference values of the “past results” of that “past result.” Depending on the results of the competition, the update preference values made either in both “past result” or in the “new result” and the “past result” and there is no need to replicate them.

An example of such a replacement algorithm is set forth below.

Initialize Optimizer system OS and parameters;

Repeat

Select two agents A₁ and A₂ from the OS using e.g.: proportional selection based on the fitness of central solution

For each free parameter with probability λ do

Copy the value of free parameter from A₁ to offspring O;

End

For each unassigned free parameter in O do

In problem specific order:

Select a value to be assigned to this free parameter from the set of possible values according to some policy based on action-values of A₂ and assign it to a free parameter;

End

Pass O through local optimizer (optimizer step);

Evaluate O; f(O) denotes fitness of O;

Compute reward r;

If f(O) is better then the fitness of central solution of A₁ then

Copy (O) to central solution of A₁;

End

Update action-values of A₁ and A₂ using reward r;

Until termination condition;

Output best solution in OS database.

Whereas: “New result” action-values are different from the “Past results” based on the OS optimization parameters the new result shall be replicated into the RL database.

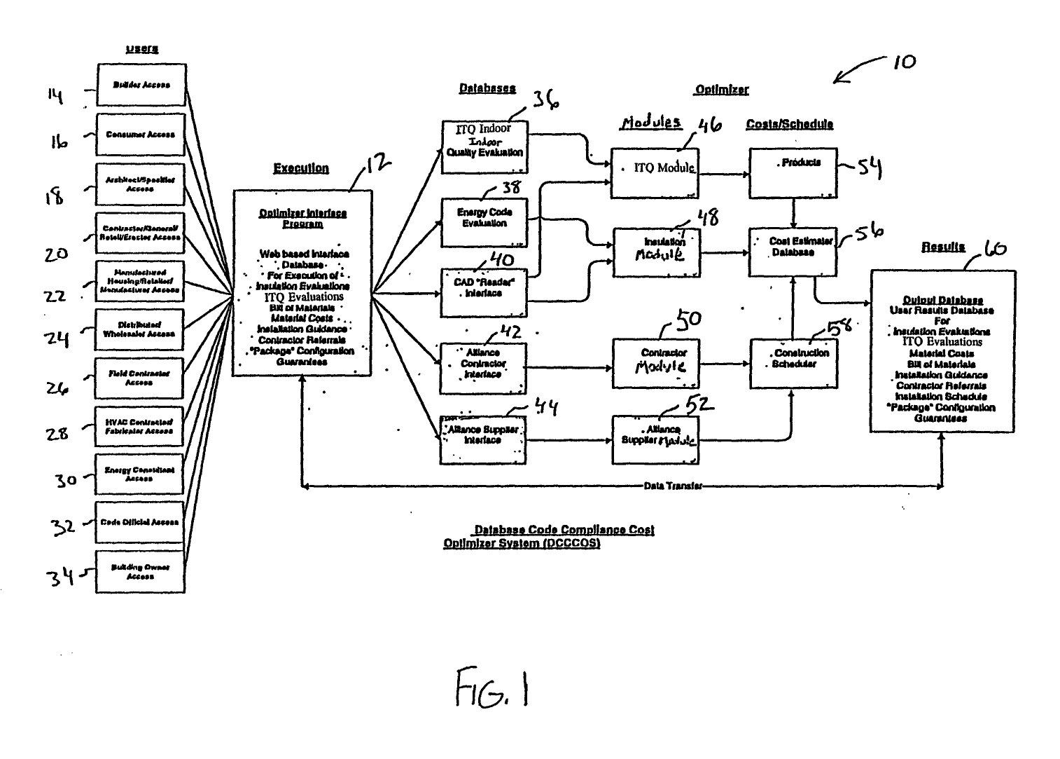

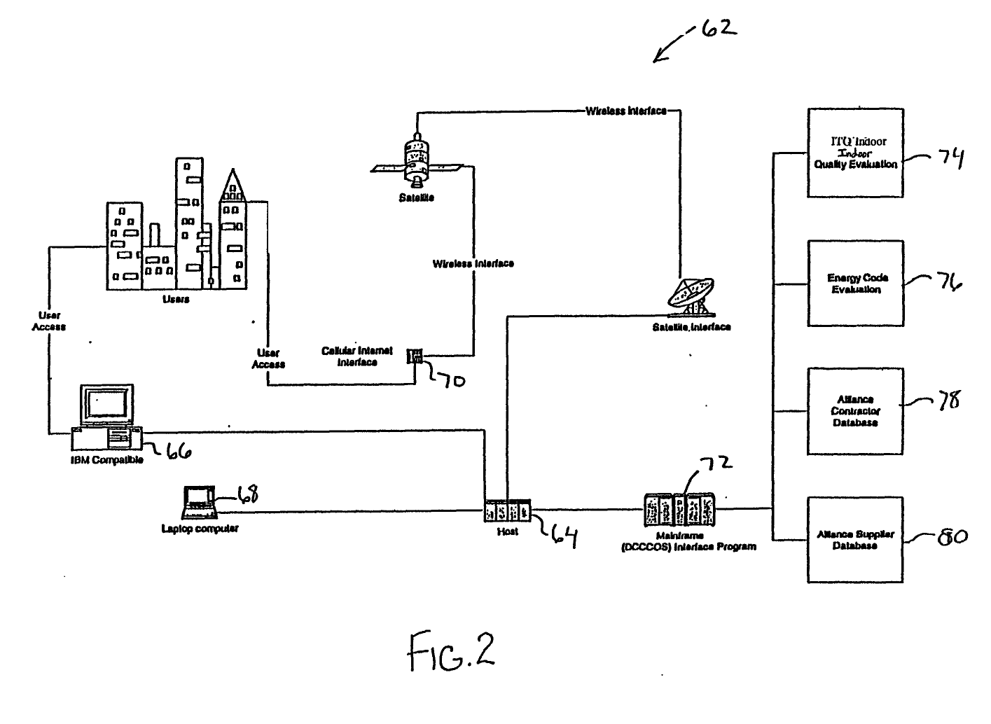

FIG. 1 illustrates a target-compliant optimization system 10 for performing the process of optimization as described above. Optimization system 10 may be implemented over a computer network, such as the Internet, intranets, LANs, and WANS.

Central to optimization system 10 is an optimizer interface program 12. Interface program 12 may comprise a Internet-based interface that may be accessed with any electronic device having a web browser. Such electronic devices may be, for example, personal computers, PDAs, or cellular telephones. Interface program 12 includes a database and appropriate software code to perform item evaluations where a lowest cost set of items, such as the insulation of the above example, may be determined. Interface program 12 may perform economic benefit analysis based on determined sets of items, taking into account such factors as payback, cashflow, and mortgage adjustments (e.g., Energy Star cost savings). Interface program 12 is also employed to perform indoor thermal quality (ITQ) evaluations and when the user wishes to upgrade the thermal efficiency of their building. Interface program 12 may also be employed to produce a bill of materials listing the items that will be needed to construct the building at an optimal cost, along with a specification for the system and associated costs for each of the items. Interface program 12 may also allow a user to purchase items and select item installers “online” with the use of, for example, an electronic device used to access interface program 12. Fees associated with any of these features may be directly and electronically charged (i.e., through an online transaction).

Further, interface program 12 may provide the user with installation guidance, such as schedules for installers to permit users to determine an appropriate installation schedule for the selected items. Guidance information may also include materials for demonstrating how the installation is to be performed. These materials are preferably available for purchase online. Demonstrations may, for example, be contained on a video tape or disk, or may be downloaded as a video file (e.g., MPEG format) from interface program 12 or a remote site to be viewed on, for example, a computer monitor. Interface program 12 may also be employed to generate contractor referrals, including contractor schedules with associated installation and construction delay costs, so that the user may select from a variety of contractors that may be employed to install the items. Interface program 12 may further be employed to produce “package” configurations and performance guarantees (i.e., for structures with defined energy efficiency features). Again, fees associated with these features may be directly and electronically charged.

By utilizing a Internet-based interface program, a variety of users may access the program using any device as described above. Merely by way of example, blocks 14-34 illustrate various users who may access interface program 12. These include, for example, builders, consumers, architect/specifiers, contractors/general/retail/erectors, manufactured housing/retailer/manufacturers, distributors/wholesalers, field contractors, HVAC contractors/fabricators, energy consultants, code officials, and building owners.

Interface program 12 may also access various databases during its operation. For example, interface program 12 may access an indoor thermal quality evaluation database 36 when determining the types of items that will be required when a user requests to upgrade the thermal efficiency of their building above a target requirement, such as the IECC. Interface program 12 may use information from database 36 to determine the most cost effective upgrade for a particular project, where energy cost savings at least equal the extra cost of the upgrade.

When conforming to the IECC, an energy code evaluation database 38 is accessed by interface program 12 to extract information on the IECC when determining the lowest cost set of items that may be used within a building.

A CAD “reader” interface database 40 is used to store CAD files, and may also be accessed by interface program 12 for determining the lowest cost set of items, as well as for performing other calculations, such as thermal calculations to determine an ITQ. Interface program 12 may also access interface database 42 to compare structural configurations and, based on these comparisons, to recommend changes in structural design to allow compliance with target requirements at lesser costs. An alliance contractor database 42 may be provided to store information on contractors that may be engaged to install the items and other components of the energy package (e.g., HVAC components). An alliance supplier interface database 44 may be provided to list suppliers that supply the various types of products and systems, as well as their associated costs.

Interface program 12 may also access various modules during its operation and accordingly charge fees online. For example, when the end user indicates that they wish to upgrade from target requirements, an ITQ module 46 is employed to calculate a lowest cost set of items that may be used. ITQ module 46 may also be employed to perform energy consumption calculations so that the end user is able to determine an estimated energy savings for the selected upgrade.

An item module 48 is employed to determine a lowest cost set of items that may be used in constructing a building. A contractor module 50 is employed to organize contractor schedules and to provide a list of available contractors and their installation costs for the items selected in the package. An alliance supplier module 52 is employed to organize available suppliers and the cost of each product carried by the supplier.

ITQ module 46 may access a products database 54 that has information on various climate control equipment as well as other energy saving materials and systems that may be accessed by ITQ module 46 when performing its analysis. A cost estimator database 56 includes information from a target requirement, such as an energy code, as well as information on the structure itself. Items module 48 accesses this information when determining a lowest cost set of items to be used in constructing the structure. A construction scheduler 58 is accessed by contractor module 50 and supplier module 52 to give possible construction schedules for constructing the structure. Construction scheduler 58 may, based on inputted update information, also provide information related to costs associated with construction time delays. Such additional costs are associated with delays resulting from the determined item installations, changes which may affect much of the overall, master construction schedule in a “chain reaction” fashion, and may also reflect such economic factors as interest rates and payment terms. This information may also be passed on to cost estimator database 56 so that an overall price for constructing the structure may be determined. The results of optimization system 10 are sent to an output database 60 and may be transferred back to optimization system 10 for visual display by using a device with a web browser as previously described.

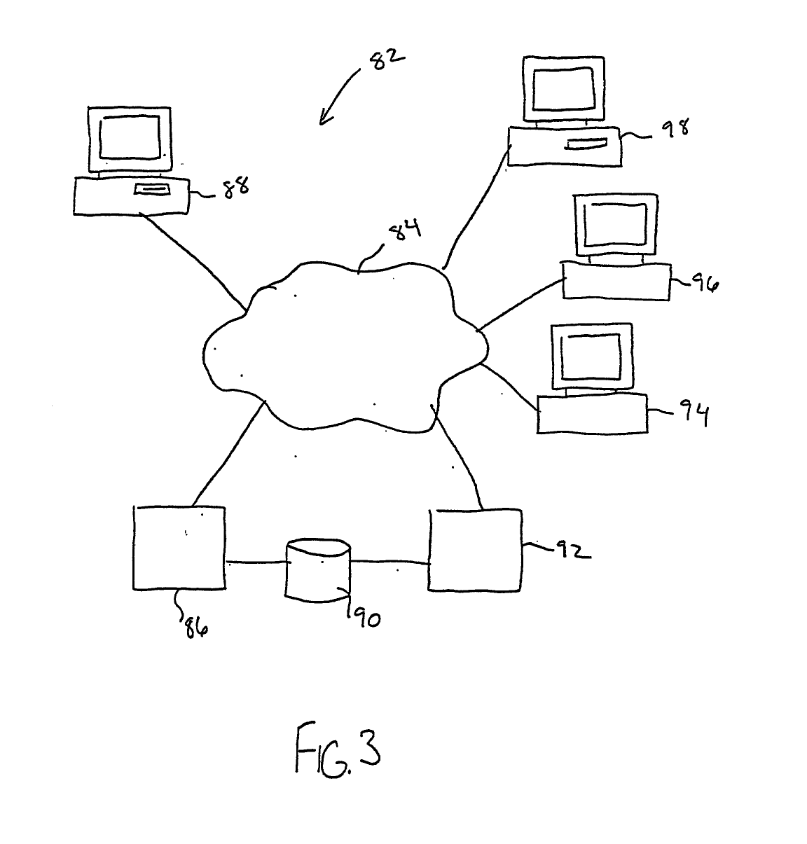

Referring now to FIG. 2, a schematic diagram of a target compliance optimization system 62 will be described. Optimization system 62 includes a host computer 64 that is representative of a computer system that is employed to interface with remote communication devices. For example, host computer 64 may serve as an interface to a personal computer 66 or a portable computer 68 (e.g., laptop or PDA) over a computer network, as is known in the art. End users may alternatively interface with host computer 64 in a wireless manner by using a cellular internet interface 70 (e.g., cellular telephone). Host computer 64 may conveniently comprise a web server for receiving and transmitting on-line various documents, including, for example, electronic documents (e.g., HTML documents), JPEG documents, and video clip documents.

Coupled to host computer 64 is a main frame or personal computer 72 that is employed to run the optimization algorithms and related programs as described herein. Although computers 64 and 72 are shown as being separate units, it will be appreciated that the functions of these two computers may be integrated into a single system.

Main frame computer 72 has access to various databases when running the various programs. For example, main frame computer 72 may access various programming modules and/or databases when performing its operations. For example, main frame computer 72 may call on an ITQ evaluation module 74 when performing an energy consumption analysis. Main frame computer 72 may utilize target evaluation module 76 when optimizing items for a given target, such as an energy code. An alliance contractor database 78 may be accessed when determining an appropriate contractor and/or a contractor schedule. An alliance supplier database 90 may be accessed to determine suppliers or manufacturers of the various building materials and systems, and to determine the cost quoted by each supplier.

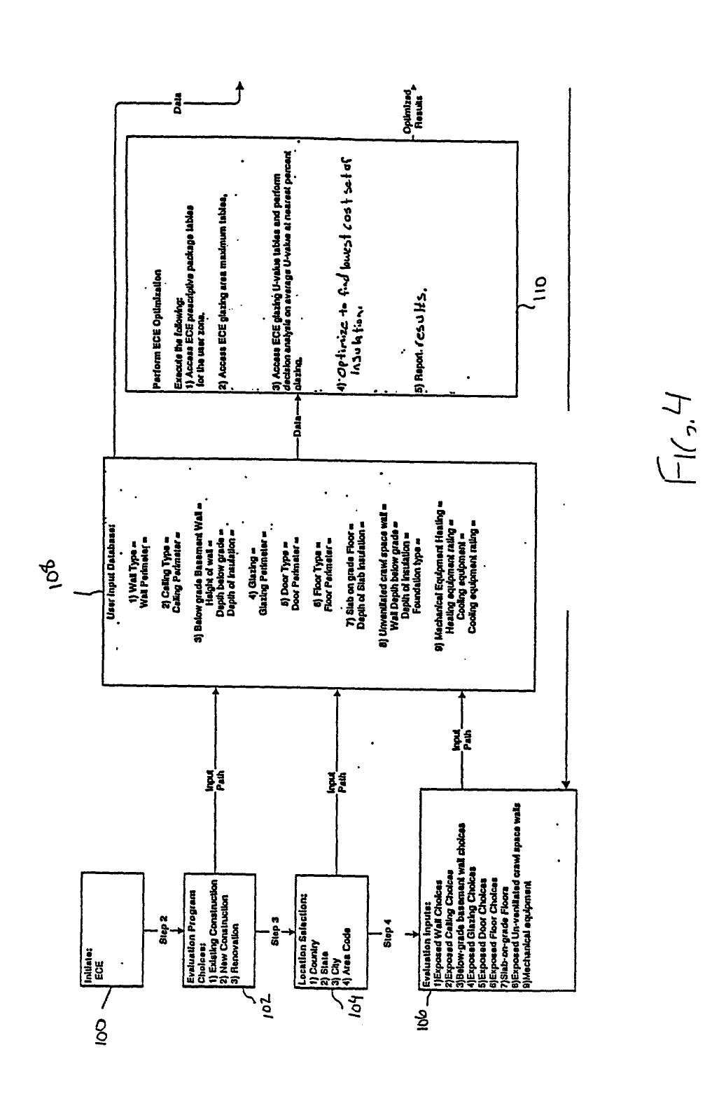

FIG. 3 is a schematic diagram of another implementation of an optimization system 82 that may be implemented using the Internet 84. System 82 includes a network server computer 86 that is configured to communicate with one or more user computers 88 over the Internet 84, as is known in the art. Server computer 86 also has access to one or more databases 90 to permit the various programs stored in server computer 86 to be operated. For example, database 90 may include information on a target requirement, suppliers/manufacturers, contractors, distributors, scheduling, energy costs, structural design, and structural codes. Optionally, an administrative server computer 92 may be coupled to database 90. Various entities 92 may access administrative server 92 to periodically update the information in database 90. For example, a supplier may use a supplier computer 94 to access administrative server computer 92 in order to update the information relating to the items provided by the supplier (including associated costs). The contractor may use a contractor computer 96 to update their construction schedule within database 90 so that end users will have access to a current schedule. For example, an energy consultant may access computer 98 to update the energy code information stored in database 90. Although not shown, it will be appreciated that other computers may be connected to Internet 84 to interface with either server computer 86 or administrative computer 92. For example, architects may have access to database 90 to enter information on a given structure so that optimization of items used in the structure may be performed.

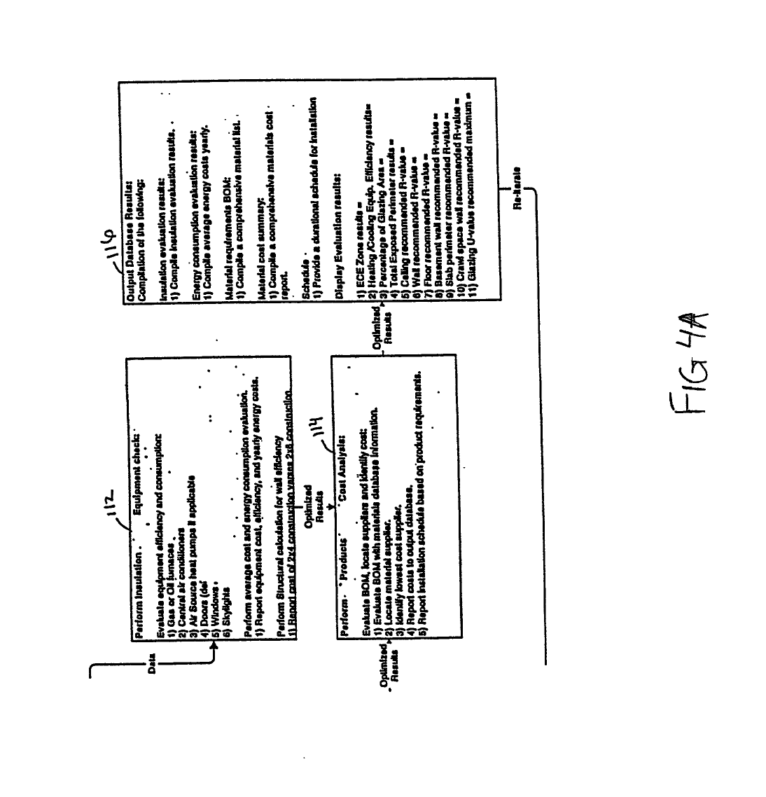

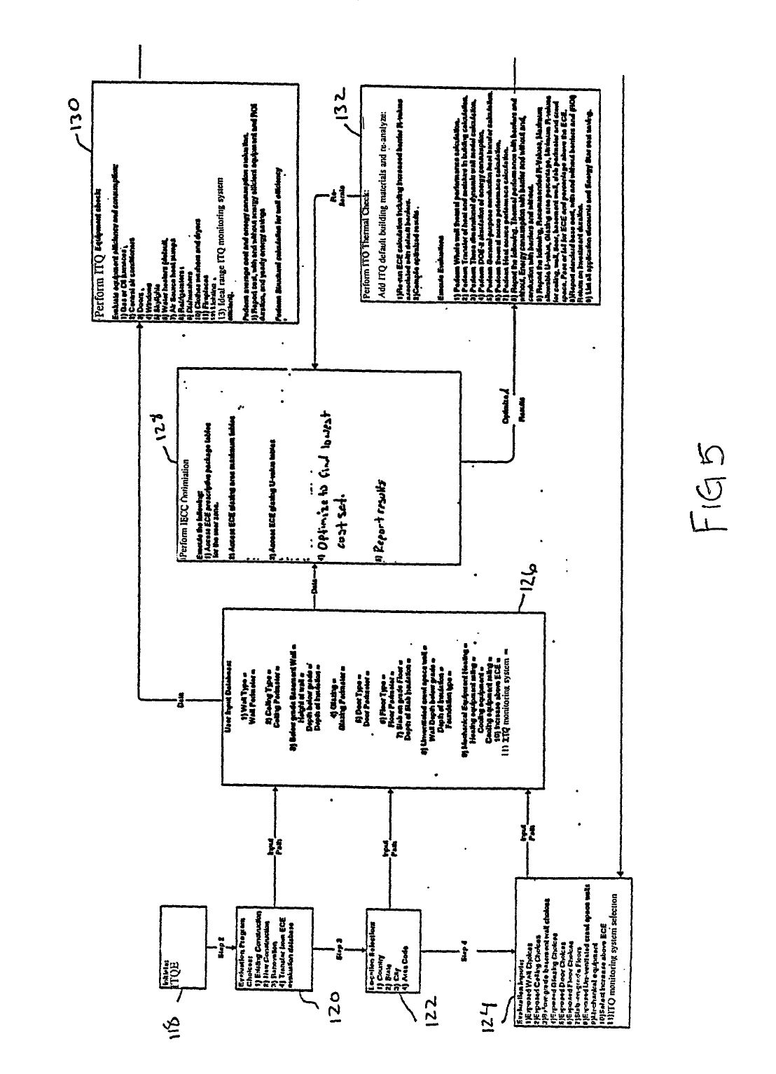

Referring now to FIGS. 4 and 4A, one method for optimizing energy-related item costs using an energy code as a target package will be described. Of course, a similar method may be implemented when a desired target is established to be an energy budget. For any of all of the following steps, an associated fee may be charged in an online fashion to the user.

The energy code evaluation (ECE) process begins at step 100. As shown in step 102, the user may then select from a list of evaluation programs, which include programs for existing construction, new construction, retrofit, and renovation. In step 104, the user is prompted to enter information on the location of the construction including the country, state, city and area code. As described hereinafter, such information may be used to determine appropriate contractors. If a desired target level of energy efficiency has not been specified, the information may also be used to determine, for example, an appropriate energy code based on the region of construction.

In step 106, the user is prompted for various evaluation inputs. For example, the user may be asked to select a type of exposed wall. This may include, for example, a custom wall, wood frame wall (16″ OC), a wood frame wall (24″ OC), a metal frame wall (16″ OC), a metal frame wall (24″ OC), a concrete or masonry wall, a log wall, a stress skin wall panel, or engineered lumber. For each wall, the user may also enter exposed dimensional values (e.g., in terms of length, width, and height), along with any details relating to thermal value (e.g., R-values associated with sheathing or siding).

Another evaluation input may be for exposed ceilings. For example, the user may select from a conventional joist ceiling, a raised truss ceiling, a ceiling constructed of stress skin ceiling panels, and the like. The user may enter thermal value details and exposed dimensional values for the exposed ceiling (e.g., in terms of length, width, and height).

A further evaluation input may be for a below-grade or above-grade basement wall. This may selected from, for example, a foundation type wood wall, a foundation type concrete wall, and the like. Further, the user may be prompted for the height of the wall, the depth that the wall is below grade, and the depth of insulation.

A further evaluation input may be for exposed glazing. This may include windows or glass doors, skylights, and the like. Further, the user may be prompted to enter exposed dimensional values in terms of length, width and height as well as the number of windows, doors, skylights, or the like.

Another evaluation input for is exposed doors. Types of doors that may be entered include, for example, metal, non-insulated, metal insulated, wood, and plastic. Exposed dimensional values in terms of length, width and height may be entered for each door. Further, the number of exposed doors may be also be entered.

An exposed floor may be also be input as an evaluation variable. This may include, for example, a radiant floor, a floor over unconditioned space, a floor over outdoor air, and the like. The user may be prompted for exposed dimensional values in terms of length and width.

Any slab-on-grade floors may also be entered as an evaluation input. Such floors may be unheated or heated. Further, the user may be prompted for the depth of insulation.

Another evaluation input is for exposed unventilated crawl space walls. For this entry, the user may be prompted for the height of the wall, the depth below grade, the depth of insulation, and whether foundation type concrete or wood is employed.

Another example of an evaluation input is mechanical equipment used for heating or cooling. Selections may include, for example, a forced air furnace, a boiler, including gas fired steam boilers, solar boilers, heat pumps, including those operating in heating mode, heating SEER, cooling mode and cooling SEER, air conditioners, and the like.

The data from steps 102, 104 and 106 may conveniently be displayed in summary form as illustrated in step 108. For example, the network server computer may send an electronic document to the user's computer to display the following information: wall type, wall perimeter, ceiling type, ceiling perimeter, below grade basement wall, height of wall, depth below grade, depth of insulation, glazing, glazing perimeter, door type, door perimeter, floor type, floor perimeter, slab-on-grade floor, depth of slab insulation, unventilated crawl space wall, wall depth below grade, depth of insulation, foundation type, mechanical equipment heating, heating equipment rating, cooling equipment, and cooling equipment rating. Of course, the transferred electronic document may contain any combination or summary of the listed products or systems. This information may also be saved in a database for subsequent retrieval and use. For example, as described hereinafter, such information may be used to calculate energy code for a particular zone, heating/cooling equipment efficiency, percentage of glazing area, total exposed perimeter, ceiling recommended R-values, wall recommended R-values, floor recommended R-values, basement wall recommended R-values, slab perimeter recommended R-values, crawl space wall recommended R-values, glazing U-value recommended maximum, and compliance with an energy code.

The process then proceeds to step 110 where ECE optimization occurs. Initially, energy code prescriptive packages are accessed for the geographic zone in which the construction is to occur. Such prescriptive packages for the IECC are commercially available. Merely by way of example, two such prescriptive package tables are set forth in Tables 502.2.4(2) and 502.2.4(3) below.

From the prescriptive package, the glazing area maximum tables are accessed and compared with the user input regarding glazing area to select a starting point for the optimization process. Conveniently, the algorithm may select the nearest range at a value within a certain range, such as within plus or minus 0.005%.

The algorithm then proceeds by evaluating the package to determine a value associated with glazing (e.g., U-value) that is associated with the calculated glazing area percentage. Optimization may then begin by iterating all possible combinations of items for ceilings, walls, floors, basement walls, slab perimeters, crawl spaces, and the like. The iteration will preferably occur within all possible combinations that fall within a certain range. During iteration, every possible combination of items will be evaluated for the above-identified components and assemblies. The ranges may be set by default or selected by the user.

As the algorithm iterates through all possible combinations, including structural changes, the algorithm determines which combinations of items will produce an acceptable UA value when installed into a building. Once all of this information has been calculated, the cost associated with each acceptable set is calculated and the costs are compared to determine a lowest cost set. In this way, the algorithm will select the lowest cost combination of items that meets the energy code criteria. That is, the algorithm will select the most cost-effective package from all possible combinations given the criteria.

The output of the optimization may include recommended R-values, maximum allowable glazing U-values, glazing area percentage, minimum R-values for ceilings, walls, floors, basement walls, slab perimeters, crawl spaces, and the like. Further, the algorithm may determine not only if the combination passed the energy code or target, but also the percentage above the code or target, if appropriate. Also, the cost of the recommended items may also be provided. In a retrofit situation, where changes are to be made to an existing structure, results of the above-described optimization may be presented as recommendations as to what structural modifications should be made to meet the desired target.

Based on the input information on heating and cooling equipment, the process may proceed to step 112 where energy consumption costs may be calculated based on either historical information or predicted values. This calculation may be based on the use of gas furnaces, oil furnaces, central air conditioners, solar/electric heating, air source heat pumps, and if applicable, doors, windows, skylights, and the like. The average cost to operate such equipment and annual energy consumption may be determined by the use of various heat transfer equations, climate factors, manufacturer estimates, the orientation of the structure, thermal mass, shading, and the like. Computer packages for calculating such information include Hot2000, available from the Canadian Home Builders Association, and DOE-2, available from the Lawrence Berkeley National Laboratory.

Once this information is calculated, it may be reported to the user in terms of equipment and energy costs (on a monthly or an annual basis, for example), adjusting for such factors as interest rates. In this way, the user is able to evaluate whether the use of certain equipment is economically practical. As described hereinafter, the input information on the heating and cooling equipment may be modified and the program rerun to evaluate equipment costs versus energy costs for different pieces of equipment. These modifications can be used in step 112 to explore economical and energy-related interactions (i.e., trade-offs) between materials and systems, thus allowing a builder to approach a balance between such items. In addition, the actual design or redesign of heating and cooling equipment configurations (e.g., for an HVAC system) may be performed in step 112 to determine the most efficient way to distribute conditioned air. Configurations for water, electrical, solar heating systems, and the like may also be similarly designed and outputted from step 112. Interactions between items and structural components (e.g., wall assemblies) may also be similarly explored.

As shown in step 114, a products cost analysis may also be performed. This process proceeds by determining a bill of materials based on the optimized information from step 110. The database may also be accessed to locate suppliers/manufacturers for the bill of materials and each supplier's advertised or negotiated prices. Since it is often convenient to only utilize a single supplier, the process may identify the lowest cost supplier for the optimized materials or systems. Further, a supplier database may be accessed to determine contractor schedules to report an installation schedule based on the product requirements. In addition, a contract between a builder and an item supplier may be automatically generated based on a selected supplier. A user may also be able to select an inspection service to ascertain that target requirements have been met post-installation. Once a target requirement has been met (e.g., IECC), a user may also be automatically offered the option to apply on-line for an energy-related mortgage (e.g., energy-efficient or EnergyStar), which may result in decreased mortgage rates for the user.

The information calculated in the optimization process is sent to an output database as illustrated in step 116. This information may conveniently be sent in electronic form to the user. Such information may include a compilation of the insulation evaluation results, average energy costs on an periodic basis, a comprehensive bill of materials, a comprehensive materials cost report, and a durational schedule for installation. Further, the database may include a display of item evaluation results as previously described. Examples of information included in the bill of materials may include for example, an optimized set of items, building materials, furnaces and heat pumps, central air conditioners (including any configuration redesigns), doors, windows, and skylights. The bill of materials may also include directions on how to install the selected package.

As shown in FIG. 4, step 116 is also connected to step 106. In this way, after an analysis has been performed, the user may modify the inputs and rerun the algorithm to determine the results of the modifications. In this way, the user may enter a variety of inputs so that more informed choices may be made by the end user.

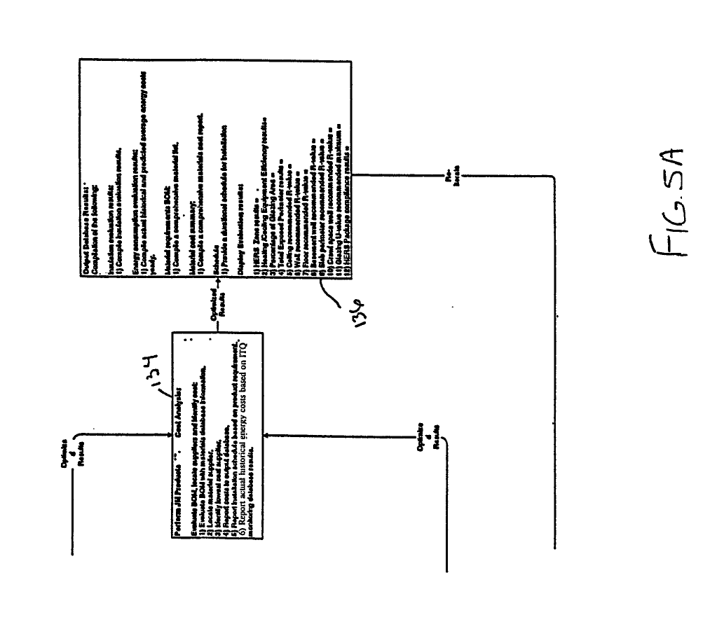

In some cases, the user may wish to determine an optimized set of items that is a certain percentage above a target or energy code. Further, in some cases the user may wish to include other energy saving materials or upgraded heating and cooling equipment during construction. FIG. 5 is an example of a process that may be used to implement such features. In the process of FIG. 5, steps 118, 120, 122, 124 and 126 are analogous to steps 100, 102, 104, 106 and 108, respectively of FIG. 4. The process of FIG. 5 differs in that additional evaluation inputs are permitted at step 124. In particular, the user may input a desired increase above the target or energy code. For example, the user may wish to be at a level that is 20%, 30%, 40% or 50% above the target or code, either below the UA value designated by an energy code or below the projected energy consumption provided by a target-compliant structure. Further, the user may also input information on an indoor thermal quality (ITQ) system. For example, the user may input information on radiant barriers, attic ventilation, moisture control devices, leakage control devices and the like. The user may also input information on top rated heating and cooling equipment, including water heaters, central air conditioners, gas or oil furnaces, air source heat pumps, refrigerators, dishwashers, clothes washers and dryers, fireplaces, and the like. The process then proceeds to step 128 where item values are optimized in a manner similar to step 110 of FIG. 4. However, the optimization process will increase the criteria by the percentage previously input by the user.

In step 130, an equipment check is performed in a manner similar to step 112 of FIG. 4A. However, the equipment check in step 130 takes into account the upgraded and/or additional equipment previously entered at step 124. The analysis may produce information on the average cost of each piece of equipment as well as energy consumption information. Further, step 130 may be employed to produce energy savings (e.g., on a yearly, monthly, or lifetime basis) obtainable by upgrading with this equipment. A return of investment analysis may also be performed to determine how long the equipment will need to be used in order to pay for their additional costs based on energy savings over time.

As shown in step 132, an ITQ thermal check may also be performed. In this analysis, the upgraded materials, such as building materials, added ventilation, moisture control devices and leakage control devices are included in the optimization analysis of step 128. More specifically, the R-values associated with the additional materials and/or pieces of equipment are added to the optimization equations of step 128 to determine which sets of items may be used in order to meet the appropriate UA criteria. Additional analysis may then occur to determine the efficiency of the building using the lowest cost set of items as well as the other upgraded materials. For example, a whole wall thermal performance calculation may be performed with the inclusion of building materials. Transfer of heat, conditioned air, and moisture in building calculations may also be performed with the inclusion of the building materials. Other calculations that may be performed include three-dimensional dynamic wall model calculations and DOE-2 simulation of energy consumption calculations. A general purpose conduction heat transfer calculation using the building materials may also be performed. Based on these calculations, a report may be generated to show the thermal performance of the building with and without the barriers. Alternatively, the report may also be based on actual measured thermal performance of a structure or portions of a structure. An energy consumption report with and without the barriers may also be provided as well as a report related to conduction, convection, and radiation, with and without barriers. The total cost of the building with and without the barriers as well as a return on investment report may also be provided to determine whether the inclusion of the additional materials is economically worthwhile.

The results of steps 130 and 132 may be passed onto step 134 for a cost analysis. In step 134, a bill of materials may be produced based on information stored in a database. Local suppliers may also be identified as well as the lowest cost supplier for the requested materials. Alternatively, a bid may be requested based on the produced bill of materials. In this situation, suppliers are able to compete for a builder's business by submitting bid amounts associated with items on the bill of materials and installation cost. The total cost of the bill of materials based on the selected supplier (who may be a bid-winner), plus any additional costs associated with delays or services (e.g., inspection), is then output to a database. An installation schedule may also be produced in a manner similar to that previously described. Further, projected or actual historical energy costs based on the results of steps 130 and 132 may be reported.

Finally, the process proceeds to step 136 where the results of the analysis are output to a database. In a manner similar to that previously described in connection with FIG. 4, various inputs may be modified in step 124 and the process reiterated to produce another set of outputs in step 136.

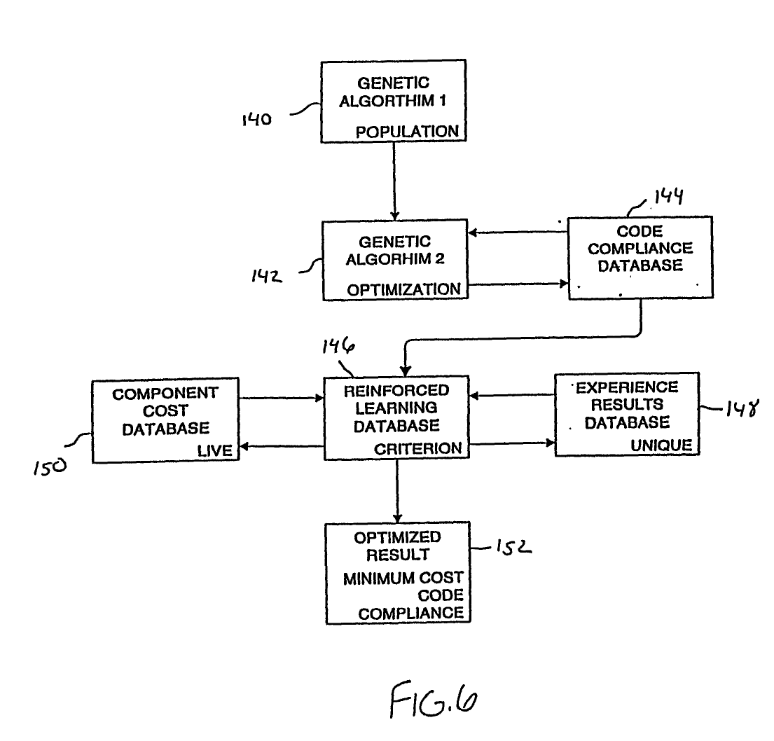

Referring now to FIG. 6, a flow chart illustrating one method for optimizing building material costs will be described. In step 140, a first genetic algorithm is employed to populate a database with information on a given structure. For example, such information may include exposed walls, ceilings, glazing, doors, floors, basement walls, unventilated crawl spaces, and the like. Once the database is populated, the process proceeds to step 142 where a second genetic algorithm optimizes the choices of items to a lowest cost set. In so doing, the second genetic algorithm extracts information from a target-compliant database as shown in step 144. This information may be transmitted to a reinforced learning database as shown in step 146. The reinforced learning database is employed to increase the efficiency of the optimization process. If the value is unique, this information is stored in an experience results database as shown in step 148. In this way, if the process is repeated, the process may jump to step 148 to determine if the result is unique. If not, the process may proceed to step 150 where a component cost database is searched for another set of solutions. The process then proceeds to step 152 where an optimized result is provided showing a minimum cost set of items that is within code compliance.

Hence, the system may be used to permit manufacturers, builders, consumers, contractors, and suppliers to work together, which allows references to flow back and forth along the supply chain, creating combined opportunities for success in the marketplace. Advantageously, the present invention has the ability to provide the user with the lowest cost combination of products and systems within target or code compliance, to provide performance guarantees associated with a selected combination, and to allow online payment of services rendered. The invention may conveniently utilize genetic algorithms to evaluate the user's input against multiple populations solutions. These solutions are checked for fitness against pre-selected criteria. Optionally, the invention may subsequently use reinforced learning algorithms to identify starting points during its iteration process. If the program has previously experienced the input, the program narrows its search towards its last encountered result. The program may continue to optimize itself as it experiences more inputs. Repeat occurrences in the database may conveniently be discarded. Further, new target or codes, costs, or manufacturing process may be added as such information is made available.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of selecting items for a project within a criteria, the method comprising the steps of:
inputting project information;
determining sets of items based on the project information that meet the criteria;
calculating for each set of items a set value; and
selecting a set of items based on the calculated set values.

2. The method of claim 1, wherein the items are stored in at least one database and each item has an associated first item value and second item value.

3. The method of claim 2, wherein the step of determining further comprises the step of calculating a first project value for the project based on the project information and the criteria, and the step of determining sets of items that are in compliance with the calculated first project value.

4. The method of claim 3, wherein the step of determining further comprises the step of iterating through combinations of first item values and determining sets of items that are in compliance with the calculated first project value based on the iterated combinations.

5. The method of claim 4, wherein the step of determining further comprises the step of calculating a second project value for the project based on the project information, and wherein the step of iterating begins at a first combination of first item values based on the second project value.

6. The method of claim 5, wherein the at least one database further comprises a table comprising a plurality of second project values and associated combinations of first item values.

7. The method of claim 2, wherein each set value is a combination of the second item values associated with each set of items.

8. The method of claim 2, wherein the step of selecting further comprises the step of selecting a set of items with the lowest set value.

9. The method of claim 8, wherein the step of selecting further comprises the step of presenting a display of the set of items with the lowest set value.

10. The method of claim 3, wherein the first project value is a UA value.

11. The method of claim 5, wherein the second project value is a glazing area percentage.

12. The method of claim 2, wherein each first item value is a R-value.

13. The method of claim 2, wherein each second item value is an item cost.

14. The method of claim 1, wherein the criteria is established based on the inputted project information.

15. The method of claim 1, wherein the criteria comprises a portion of a building code.

16. The method of claim 3, wherein the building code is an energy code.

17. The method of claim 1, wherein the inputted project information comprises structural information.

18. The method of claim 17, wherein the structural information comprises information on main walls, ceilings, floors, basement walls, doors, glazing, slab perimeter, or crawl space walls.

19. The method of claim 3, wherein the inputted project information comprises mechanical equipment information.

20. The method of claim 19, wherein the mechanical equipment information comprises information on a forced air furnace, a boiler, a heat pump, or an air conditioner.

21. The method of claim 3, wherein the inputted project information comprises upgrade information, and wherein the step of calculating a first project value further comprises the step of increasing the first project value based on the upgrade information, and the step of redetermining sets of items that are in compliance with the increased first project value.

22. The method of claim 21, wherein the upgrade information includes information on at least one energy saving component.

23. The method of claim 22, wherein the upgrade information includes information indicating an efficiency percentage upgrade above the criteria.

24. The method of claim 21, further comprising the step of determining energy consumption information based on the selected set of items.

25. The method of claim 2, wherein each item comprises information on one of a type of building material or a type of building system.

26. The method of claim 21, wherein a type of building material is an insulation material.

27. The method of claim 3, further comprising the step of generating a bill of materials based on the selected set of items.

28. The method of claim 27, wherein the step of generating further comprises the step of displaying the total amount of items required to construct the project.

29. The method of claim 27, wherein the step of generating further comprises the step of displaying information on suppliers based on the bill of materials.

30. The method of claim 2, further comprising the step of updating the second item values.

31. The method of claim 30, wherein the step of updating further comprises the step of sending a document containing updated second item value information to an administrative server computer that is configured to update the at least one database.

32. The method of claim 2, wherein the database further includes contractor scheduling information, and further comprising the step of determining an installation schedule and associated costs for the selected set of items based on the contractor schedule information and installation costs.

33. A system for selecting a set of items that meet a given criteria when included within a project, the system comprising:
a central computer having a processor and an input device for receiving information on a project;
at least one database having a list of items that may be used in constructing the project and a first value for each of the items;
code for determining sets of the items that may be used in constructing the project;
code for calculating a total first values for each set of items; and
code for selecting a set of items based on the calculated total first values.

34. The system of claim 33, wherein each items is one of a building material and a building system, the project is a structure, each first value is a item cost, and each total first value is the sum material cost of a set of items.

35. The system of claim 33, wherein the code to select a set of items selects the set of items with the lowest total first value.

36. A system as in claim 34, wherein the items comprise different types of insulation, wherein the criteria is an energy code that uses a UA value for a given structure, and further comprising code to calculate a UA value based at least in part on input structure information, and code to determine sets of insulation that may be used in constructing the structure in compliance with the UA value.

37. A system as in claim 36, wherein the at least one database further includes glazing area percentages and associated items that may be used in constructing a structure while complying with the energy code, and further comprising code to calculate at least one glazing area percentage for the structure based on the input structure information, and code to determine the sets of items by first determining the items that are associated with the calculated glazing area percentage.

38. A system as in claim 37, further comprising code to evaluate combinations of other items that are associated with glazing area percentages that are closest in value to the calculated glazing area percentage.

39. A system as in claim 36, further comprising code to decrease the UA value by a certain percentage, and code to determine another lowest cost set of item based on the decreased UA value.

40. A system as in claim 39, wherein the at least one database includes climate control equipment information, and further comprising code to calculate energy consumption information based on the new lowest set of insulation and the climate control information.

41. A system as in claim 36, wherein the computer further includes input information on other energy saving components used in constructing the structure, and further comprising code to recalculate the UA value for the structure and to determine another lowest cost set of items based on the recalculated UA value.

42. A system as in claim 33, wherein the central computer comprises a network server computer and further comprising at least one user computer that is adapted to be coupled to the network server computer over a network to transmit the structure information to the network server computer.

43. A system as in claim 36, further comprising an administrative server computer that is adapted to receive updated material cost information and to update the at least one database with the updated material cost information.

44. A method for optimizing item costs used in an application within a given criteria, the method comprising the steps of:
inputting into a processor information on the project;
determining with the processor sets of items that may be used with the project that meet the given criteria;
calculating with the processor the cost of each set of items to determine a lowest cost set; and
producing a visual display of the lowest cost set.

45. A method for optimizing building material costs used in constructing a structure while complying with a given code, the method comprising the steps of:
inputting into a first computer having a processor information on the structure;
determining with the processor sets of building materials that may be used in constructing the structure while complying with a given code;
calculating with the processor the cost of each set of building materials to determine a lowest cost set; and
producing a visual display of the lowest cost set.

46. A method as in claim 45, wherein the building materials comprise different types of insulation that are stored in an at least one database, wherein the code comprises an energy code having a UA value for the structure that is determined based at least in part on the entered information, and further comprising determining sets of items that may be used in constructing the structure in compliance with the UA value.

47. A method as in claim 46, wherein the step of determining the lowest cost set of items comprises associating each item with a cost that is stored in the at least one database, summing the costs for each set, and comparing costs to determine the lowest cost set.

48. A method as in claim 46, wherein the at least one database further comprises glazing area percentages that are associated with items that may be used in constructing a structure while complying with the energy code, and further comprising calculating at least one glazing area percentage for the structure based on the input information, and wherein the step of determining the sets of items begins by first determining the items that are associated with the calculated glazing area percentage.

49. A method as in claim 48, wherein the step of determining the sets of items further comprises evaluating combinations of other items that are associated with glazing area percentages that are closest to the calculated glazing area percentage.

50. A method as in claim 45, wherein the information on the structure comprises various structural elements used to construct the structure and the configuration of the structure.

51. A method as in claim 50, wherein the structure information is selected from a group consisting of main walls, ceilings, floors, basement walls, slab perimeter and crawl space.

52. A method as in claim 46, wherein the input information further includes climate control equipment to be used in the structure, and further comprising calculating energy consumption information based on use of the lowest cost set of insulation and the input climate control equipment.

53. A method as in claim 52, further comprising decreasing the UA value by a certain percentage, and determining another lowest cost set of item based on the decreased UA value.

54. A method as in claim 53, further comprising calculating energy consumption information based on the new lowest set of insulation.

55. A method as in claim 46, further comprising entering information on other energy saving components used in constructing the structure, and further comprising recalculating the UA value for the structure and determining another lowest cost set of items based on the recalculated UA value.

56. A method as in claim 46, wherein the material types are defined by R-values, and further comprising displaying the R-values for each type of insulation in the lowest cost set.

57. A method as in claim 56, further comprising calculating and displaying the total amount of each type of insulation required in building the structure.

58. A method as in claim 45, wherein the step of producing the visual display comprises sending an electronic document from the processor to a second computer.

59. A method as in claim 45, wherein the step of inputting the structure information comprises receiving the information from an electronic document that was sent from a second computer.

60. A method as in claim 46, further comprising periodically updating the cost information.

61. A method as in claim 60, wherein the updating step comprises sending an electronic document containing the updated cost information to an administrative server computer that is configured to update the at least one database.

62. A method as in claim 46, wherein the at least one database further includes contractor scheduling information, and further comprising determining an installation schedule for the set of lowest cost items based on the contractor schedule information.

63. A method as in claim 62, further comprising periodically updating the scheduling information.

64. A method as in claim 63, wherein the updating step comprises sending an electronic document containing the updated scheduling information to an administrative server computer that is configured to update the at least one database.

65. A method as in claim 46, wherein the at least one database includes supplier information on suppliers that sell the items at a given cost, and further comprising determining a lowest cost supplier for the lowest cost set of insulation.

66. A method for optimizing building material costs used in constructing a structure while complying with a given code, the method comprising the steps of:
receiving at a network server computer having a processor information on a structure:
determining with the processor sets of building materials that may be used in constructing the structure while complying with a given code;
calculating with the processor the cost of each set of building materials to determine a lowest cost set; and
transmitting information on the lowest cost set to a user computer over a network.

67. A method as in claim 66, wherein the building materials comprise different types of insulation that are stored in a at least one database, wherein the code requirement comprises an energy code having a UA value for the structure that is determined based at least in part on the entered information, and further comprising determining sets of items that may be used in constructing the structure in compliance with the UA value.

68. A method as in claim 67, wherein the step of determining the lowest cost comprises associating each type of insulation with a cost, summing the costs for each set, and comparing costs to determine the lowest cost set.

69. A method as in claim 68, wherein the at least one database further includes glazing area percentages and associated items that may be used in constructing a structure while complying with the energy code, and further comprising calculating at least one glazing area percentage for the structure based on the input information, and wherein the step of determining the sets of items begins by first determining the items that are associated with the calculated glazing area percentage.

70. A method as in claim 69, further comprising periodically receiving at the network server computer updated cost information.

71. A system for selecting a lowest set cost associated with a set of items that meet a given criteria, the system comprising:
a central computer having a processor and an input device for receiving information on a structure;
at least one database having a list of items that may be used in constructing the structure and an item cost associated with each item;
code to determine sets of the items that may be used in constructing the structure;
code to calculate a set cost for each set of items; and
code to determine the lowest set cost.

72. A system as in claim 71, wherein the items comprise different types of insulation, wherein the criteria is an energy code that uses a UA value for a given structure, and further comprising code to calculate a UA value based at least in part on input structure information, and code to determine sets of insulation that may be used in constructing the structure in compliance with the UA value.

73. A system as in claim 72, wherein the at least one database further includes glazing area percentages and associated items that may be used in constructing a structure while complying with the energy code, and further comprising code to calculate at least one glazing area percentage for the structure based on the input structure information, and code to determine the sets of items by first determining the items that are associated with the calculated glazing area percentage.

74. A system as in claim 73, further comprising code to evaluate combinations of other items that are associated with glazing area percentages that are closest in value to the calculated glazing area percentage.

75. A system as in claim 72, further comprising code to decrease the UA value by a certain percentage, and code to determine another lowest cost set of item based on the decreased UA value.

76. A system as in claim 75, wherein the at least one database include climate control equipment information, and further comprising code to calculate energy consumption information based on the new lowest set of insulation and the climate control information.

77. A system as in claim 72, wherein the computer further includes input information on other energy saving components used in constructing the structure, and further comprising code to recalculate the UA value for the structure and to determine another lowest cost set of items based on the recalculated UA value.

78. A system as in claim 71, wherein the central computer comprises a network server computer and further comprising a user computer that is adapted to be coupled to the network server computer over a network to transmit the structure information to the network server computer.

79. A system as in claim 72, further comprising an administrative server computer that is adapted to receive updated material cost information and to update the at least one database with the updated material cost information.

80. The method of claim 2, wherein the criteria comprises an energy budget.

81. The method of claim 3, wherein the first project value is an energy baseline level.

82. The method of claim 25, wherein one of a type of building system is a HVAC system.

83. A system as in claim 34, wherein the criteria is an energy budget, and further comprising code to calculate a energy baseline level based at least in part on input structure information, and code to determine sets of insulation that may be used in constructing the structure in compliance with the energy baseline level.

84. The method of claim 2, further comprising the step of analyzing interactions between at least two of the items based on their associated first item values and second item values.

85. The method of claim 2, further comprising the step of analyzing interactions between at least one of the items and a structural component based on an associated first item value and second item value.

86. The method of claim 32, comprising the step of determining delay costs based on the determined installation schedule.

87. The method of claim 32, comprising the step of guaranteeing the achieving of a target requirement.

88. The method of claim 32, comprising the step of charging a fee.

89. The system of claim 33, wherein received project information is a CAD file.

90. The method of claim 58, wherein the second computer is a remote computer.

91. The method of claim 62, wherein the step of determining an installation schedule comprises the step of updating a master installation schedule.

92. The method of claim 56, comprising the step of generating a report showing thermal performance of the structure based on actual measured thermal performance of determined sets of items and energy saving components.
